(19) United States
(12) Patent Application Publication
(10) Pub. No.: US 2024/0153069 A1
(43) Pub. Date: May 9, 2024

(54) METHOD AND ARRANGEMENT FOR TESTING THE QUALITY OF AN OBJECT

(71) Applicant: Visometry GmbH, Darmstadt (DE)

(72) Inventors: Florian Schmitt, Wiesbaden (DE); Michael Schmitt, Muhlheim (DE); Sarah Grohmann, Darmstadt (DE); Benjamin Audenrith, Darmstadt (DE); Lukas Giesler, Darmstadt (DE)

(21) Appl. No.: 18/269,161

(22) PCT Filed: Dec. 14, 2021
(86) PCT No.: PCT/EP2021/085750

§ 371 Date: Jan. 12, 2024

(30) Foreign Application Priority Data
Dec. 22, 2020 (DE) 10 2020 134 680.8

(51) Int. Cl. G06T 7/00; G06T 7/246; G06T 7/73; H04N 23/60; H04N 23/63

(52) U.S. Cl. CPC G06T 7/001; G06T 7/251; G06T 7/75; H04N 23/635; H04N 23/64; G06T 2200/24; G06T 2207/30244

(57) ABSTRACT

The invention relates to a method for testing quality of an object in a real environment using a camera, an optical display device, and a processing apparatus, the method including the following steps: defining a test geometry and a reference geometry in a computer-assisted data mode; defining a test pose, in which the camera should be placed by the user as target positioning for a quality test to be carried out of the object to be tested; and visualizing the test pose on the optical display device. In a second phase, at least one image of the real environment is captured by the camera, the pose of which camera is in a range that includes the test pose, and the test geometry and the reference geometry in the image are tracked. Furthermore, a pose of the tracked test geometry in relation to the reference geometry and at least one parameter are determined on the basis of how the pose of the tracked test geometry is in relation to a target pose of the test geometry defined within the data model. A quality indicator is also determined on the basis of the at least one parameter and is output to the user via a human-machine interface.

This application claims priority to PCT Patent Appln. No. PCT/EP2021/085750 filed Dec. 14, 2021, which claims priority to German Patent Appln. No. 10 2020 134 680.8 filed Dec. 22, 2020, which are herein incorporated by reference.

### BACKGROUND OF THE INVENTION

### 1. Technical Field

The present invention relates to a method for testing quality of an object in a real environment using at least one camera for capturing at least one image of the real environment, an optical display device and a processing apparatus, which are connectable with the at least one camera and the optical display device. The invention further relates to a computer program product for executing such method and a corresponding arrangement for testing quality of an object.

### 2. Background Information

Today, trained workers often carry out the various testing tasks involved in quality control processes, for example in production. For this purpose, detailed information on the currently manufactured product configuration is provided in a so-called “Product Information Paper”, which is either printed out and attached or is transferred to a mobile system.

This conventional approach is very flexible as the workers are continuously being trained to meet evolving requirements, yet fatigue can lead to increased mistakes. When such mistakes in the production process go unnoticed, the subsequent costs are often significant (see B. Jung, S. Welder, and J. Wappis, “Qualitatssicherung im Produktionsprozess (Quality Assurance during the Production Process)”, Hanser, 2013; V. B. Sommerhoff, A. Brecht, and M Fiegler, “Moderne Ansatze der Qualitatssicherung in der Serienfertigung (Modern Approaches to Quality Assurance in Series Production)”, DGQ, 2014).

Double-checking the correct geometric arrangement of complex products or assemblies is therefore often supported by (physical) templates or measuring gauges. However, each product variant requires a dedicated measuring gauge. However, this results in low adaptability, especially in the so-called ramp-up phase (product launch phase), because changes to the templates require a complex production process for the measuring gauges. To this end, automated computer vision-based test methods are increasingly being developed, which are, for example, used for long-term continuous mass production in the field of electronics (see Bo Su, Eric Solecky, Alok Vaid, “Introduction to metrology applications in IC manufacturing”, SPI.E. Press, 2015).

Computer vision-based test methods are also already being used in the testing facilities of complex automobile production lines. Examples are image-based test systems provided by Neurocheck (see https://www.neurocheck.de/systemloesungen/anwendungsgebiete/montagekontrolle/) or VMT (see https://vmt-vision-technology.com/files/225/vmt-unternehmen-de-lq.pdf), which are being trained with reference images. Such training efforts are, however, very demanding due to the large number of reference images that must first be collected and marked (“labelled”) as OK/nOK (“okay/not okay”) through user interaction to train the underlying classification networks. Moreover, this approach is very inflexible as new image data must be used to train for each product variant or change. For this reason, both the product structures being tested and the test equipment for the current product variant are labelled with bar codes, and both codes are automatically read in and verified against one another. This allows to at least test whether the correct components have been installed; however, without considering the correct pose thereof (see Strassner, M., Fleisch, E., “The Promise of Auto-ID in the Automotive Industry”, White Paper, Auto-ID Center, MIT, Cambridge (MA), 2003).

Other approaches also use so-called augmented reality systems for quality assurance. The following systems can be mentioned here as examples: The “Digital-assisted Operator” system provided by Diota (see https://diota.com/) supports the real-time overlay of CAD models in the camera image for an augmented reality visualization. However, it does not allow for the implementation of automated quality checks. Likewise, the “FARO Visual Inspect” system provided by FARO (see https://www.faro.com/de-de/produkte/3d-manufacturing/visual-inspect/) supports the real-time overlay of CAD models in the camera image for an augmented reality visualization. Also in this case, quality analysis relies only on the tester's observations and is not automated.

Although these systems use Augmented Reality (“AR”) and enable the visualization of CAD data overlaid on an object that is captured by the camera, quality control can only be carried out by the tester through visual comparison conducted by themselves in the augmented reality visualization. The AR test can neither be reliably reproduced at a later point in time nor be automated, because it is the tester's observation using augmented reality visualization that determines whether the result is OK (“okay”) or nOK (“not okay”).

The object of the present invention is to provide a method and an arrangement for testing quality of an object, which can be used to implement a high-quality, automated and reproducible quality check of an object to be tested, for example in production.

### SUMMARY OF THE INVENTION

The invention relates to a method and an arrangement for testing quality of an object, as well as a computer program product, according to the features defined in the appended claims.

According to a first aspect, the present invention relates to a method for testing quality of an object in a real environment using at least one camera for capturing at least one image of the real environment, an optical display device and a processing apparatus, which is connectable with the at least one camera and the optical display device, the method comprising the following steps:
providing a computer-assisted data model of an object of the real environment to be tested,
defining a test geometry as a geometric sub-area within the data model,
defining a reference geometry within the data model as a reference system for conducting a test,
defining, by the processing apparatus, a test pose, in which the camera should be placed by the user as target positioning for a quality test to be carried out of the object to be tested,
visualizing, by the processing apparatus, the test pose on the optical display device,
capturing, by the camera, at least one image of the real environment, the pose of which camera is in a range that includes the test pose, and tracking, by the processing apparatus, the test geometry and the reference geometry in the at least one image,
determining, by the processing apparatus, a pose of the tracked test geometry in relation to the reference geometry, and determining at least one parameter on the basis of how the pose of the tracked test geometry is in relation to a target pose of the test geometry defined within the data model,
determining, by the processing apparatus, a quality indicator containing information about at least one quality property of the object to be tested on the basis of the at least one parameter, and
outputting, by the processing apparatus, the quality indicator to the user via a human-machine interface.

The invention has the advantage of combining these measures such as to implement a high-quality, automated and reproducible quality check for an object to be tested, for example in production. Firstly, this is because the poses (position and orientation) of the test geometry and the reference geometry tracked in the image are correlated with one another (i.e. the reference geometry and the test geometry are registered in relation to one another) in order to register the geometric orientation of the associated real objects (object to be tested and reference object) in relation to one another, thereby obtaining calculated and thus automatable information about at least one quality property of the object to be tested in the form of a quality indicator. Moreover, such a reliable and automated quality check can also be reproduced at a later point in time, as a previously defined test pose is visualized for the user on the optical display device. The visualization of such a test pose allows the user (and later also other users) to reliably position the camera, allowing for comparable, reproducible quality tests to be carried out on the same or similar product, also at a later point in time. The quality indicator (e.g. OK/nOK for “okay”/“not okay”) is output to the user via a human-machine interface, e.g. visually or acoustically, allowing for an automated quality test, which then no longer depends exclusively on whether the user has subjectively assessed the respective individual quality test as okay or not okay based only on visual comparison.

According to this first aspect, the invention also relates to an arrangement for testing quality of an object in a real environment by means of a processing apparatus, which is couplable with at least one camera for capturing at least one image of the real environment, and an optical display device, with the processing apparatus being configured to carry out the steps described above. According to one embodiment of the invention, a pose of the camera is registered in a coordinate system of the reference geometry.

According to another embodiment of the invention, the quality indicator indicates first information that indicates satisfactory quality (e.g. “OK”) if the pose of the tracked test geometry deviates by less than a predetermined distance from a target position of the test geometry defined within the data model, and/or deviates by less than a predetermined angle from a target orientation of the test geometry defined within the data model. For example, such a predetermined distance lies within a range of 1 mm, and such a predetermined angle lies within a range of 1 degree.

In another aspect, the present invention relates to a method for testing quality of an object in a real environment using at least one camera for capturing at least one image of the real environment, an optical display device and a processing apparatus, which is connectable with the at least one camera and the optical display device, the method comprising the following steps:
providing a computer-assisted data model of an object of the real environment to be tested,
defining a test geometry as a geometric sub-area within the data model,
defining, by the processing apparatus, a test pose in which the camera should be placed by the user as target positioning for a quality test to be carried out of the object to be tested,
visualizing, by the processing apparatus, the test pose on the optical display device,
capturing, by the camera, at least one image of the real environment, the pose of which camera is in a range that includes the test pose, and tracking, by the processing apparatus, one or more edges in the image in relation to the test geometry,
determining, by the processing apparatus, first edges in the image that reach or exceed a predefined first degree of matching between the data model and the image, and second edges in the image that fall below a predefined second degree of matching between the data model and the image,
determining, by the processing apparatus, a quality indicator containing information about at least one quality property of the object to be tested on the basis of the determined first and/or second edges, and
outputting, by the processing apparatus, the quality indicator to the user via a human-machine interface.

In principle, this method combines the effects and advantages as described above in relation to the first aspect. In contrast to the first aspect, the edge-based test can be carried out without referring to a reference geometry. For example, an OK/nOK classification in the form of a quality indicator can be conducted by using a ratio of the second edges to the total number of edges rendered in the image.

According to the other aspect, the invention also relates to an arrangement for testing quality of an object in a real environment by means of a processing apparatus which is couplable with at least one camera for capturing at least one image of the real environment and an optical display device, with the processing apparatus being configured to carry out the steps described above.

According to one embodiment of the invention, the definition of the test geometry within the data model and/or the definition of the reference geometry within the data model is instructed by the user and stored in the processing apparatus. The definition of the test geometry or the reference geometry refers to the data-related set-up or the data-related storage of the test geometry or the reference geometry in the processing apparatus. The test geometry and/or the reference geometry in the processing apparatus may also be defined by reading the data of the test geometry or the reference geometry into the processing apparatus from another data processing device.

The computer-assisted data model is, for example, a CAD model, which contains a data model (for example as a part geometry) of the object to be tested. For example, part geometries of one or more test objects are specified on the basis of CAD data.

According to one embodiment of the invention, to determine the test pose, the user specifies within the data model a camera pose from which the object to be tested and, if the reference geometry has been defined, at least part of the reference geometry are visible for the camera. This allows for a quality test that can be reliably carried out from the test pose at a later point in time.

According to one embodiment of the invention, the processing apparatus comprises at least one first data processing device and one second mobile data processing device. The definition of the test geometry and/or the definition of the reference geometry is instructed by the user on the first data processing device, for example on a stationary or mobile PC (laptop) at the workplace. Once completed, the defined test geometry or reference geometry, respectively, is transferred from the first data processing device to the mobile data processing device, for example to a tablet computer having an integrated camera, which is used to carry out the quality test.

According to one embodiment of the invention, the test pose is specified in relation to the object to be tested, and the visualization of the test pose is carried out on the optical display device in relation to the object to be tested. This allows for a clear visualization of the pose from which the user is to carry out the quality test of the object to be tested.

In another embodiment, the visualization of the test pose on the optical display device is provided by the processing apparatus and is displayed as at least one marking, specifically a virtual frame, in the field of view of an augmented reality application on the optical display device. This allows for an easily understandable visualization of the pose from which the user is to carry out the quality test of the object to be tested.

According to one embodiment of the invention, the distance between the marking and the object to be tested is output to the user with the visualization of the test pose. This also serves to improve the user's understanding, allowing the user to verify that the quality test is being carried out correctly.

According to another embodiment, the visualization of the test pose on the optical display device is carried out by the processing apparatus such as to additionally show at least one floor marking, indicating to the user where on the floor the user should position themselves to assume the test pose. This also provides the user with an easily understandable visualization of the pose from which the user is to carry out the quality test of the object to be tested.

According to one embodiment of the invention, before capturing the at least one image of the real environment with the camera, the pose of the camera in relation to the test pose is tracked by the processing apparatus, and upon determining that the tracked camera pose deviates by more than at least one predefined parameter from a target orientation and/or the target position of the test pose, the user is notified via the human-machine interface that the camera should not capture the at least one image of the real environment. Otherwise, the user is notified that the camera can capture the at least one image of the real environment. The user can thereby receive clear instructions about when a quality test is to be carried out, thus preventing incorrect quality tests.

For example, the processing apparatus, upon determining that the tracked camera pose deviates by more than the at least one predefined parameter from a target orientation and/or a target position of the test pose, does not allow for a subsequent quality test of the object to be tested. This can prevent an incorrect quality test if the deviation of the camera pose is too high.

According to one embodiment of the invention, at least part of the processing apparatus is implemented as a mobile data processing apparatus, which preferably is contained in a mobile PC (laptop), tablet computer, smartphone or wearable computer or is coupled to such a computer.

According to another embodiment, at least part of the processing apparatus, the camera and the optical display device are integrated in a common housing. For example, they are integrated in a tablet computer.

According to another embodiment, at least a first part of the processing apparatus is implemented as at least one remote computer (i.e. a computer that is remote from the quality test site, such as a server computer) and a second part of the processing apparatus is implemented as a mobile data processing apparatus, which can be coupled to one another. For example, the remote computer can be a company server computer that is connected to the mobile data processing apparatus (for example a tablet computer) through the company network, or a server computer that is, for example, located on an external server farm. For example, the remote computer(s) and the mobile data processing apparatus are connected to one another through a network, such as a company network or the Internet.

The invention also relates to a computer program product comprising software code sections that are configured to execute a method according to the present invention when loaded to an internal memory of at least one data processing apparatus, for example a tablet computer. The computer program product can be a volatile or non-volatile storage medium or can be located on or comprise a volatile or non-volatile storage medium.

All embodiments described herein that relate to the method can also be applied analogously to an arrangement as described herein, with the processing apparatus being adapted accordingly with suitable hardware and/or software to carry out the different method steps. The processing apparatus may be one or more discrete systems, for example a mobile PC, a tablet computer and/or smartphone, or a distributed system that uses several data processing apparatuses with separate housings, as described above.

For example, computationally intensive processing steps, such as determining poses or tracking, may be outsourced to a powerful server computer, which then returns the respective result to the mobile computer, e.g. a tablet computer. In addition, other distributed applications are also possible, depending on the specific circumstances.

### BRIEF DESCRIPTION OF THE DRAWINGS

The invention is explained in more detail below with reference to the figures shown in the drawing, illustrating embodiments of the invention.

FIG. 1A is an example of an object to be tested, or part thereof, in the form of a product with a complex geometric shape,

FIG. 1B is another example of an object to be tested, or part thereof, in the form of a product with a complex geometric shape,

FIG. 2 is an embodiment of a computer-assisted data model, here in the form of a CAD model, which defines a test geometry,

FIG. 3 is an embodiment of a computer-assisted data model based on the data model according to FIG. 2, which defines a reference geometry,

FIG. 4 is an embodiment of a product to be tested with a visualization of the test pose in the form of a marking implemented as a frame,

FIG. 5 is another embodiment of a product to be tested with visualizations of different test poses in the form of frames and associated floor markings that indicate a corresponding position where the tester should position themselves on the floor,

FIG. 6 is an arrangement for testing the quality of an object according to one embodiment of the invention,

FIGS. 7A and 7B are embodiments of a product to be tested with a visualization of the test poses in the form of a marking implemented as a frame at different points in time,

FIGS. 8A and 8B are a views of a visual display device during a quality test process according to an embodiment, in which a tracked camera pose is invalid for automated testing (FIG. 8A), and in which a tracked camera pose is valid for automated testing (FIG. 8B),

FIGS. 9A and 9B are different stages of a product to be tested according to one embodiment, where a result of the quality test is found to be okay (FIG. 9A) or found to be not okay (FIG. 9B),

FIGS. 10A and 10B are embodiments of a product to be tested, wherein the quality test is carried out on the basis of an edge-based test without referring to a reference geometry.

### DETAILED DESCRIPTION OF THE INVENTION

In the following, several embodiments, some of which cover different aspects of the present invention, are described. In some of them, different objects to be tested are presented, here in the form of industrially manufactured products. However, the type of product in question has no restrictive effect whatsoever on the method used in each case or on the respective steps thereof, so the features described in relation to one exemplary embodiment are easily transferable to the other embodiments described or they can also be partially combined with one another.

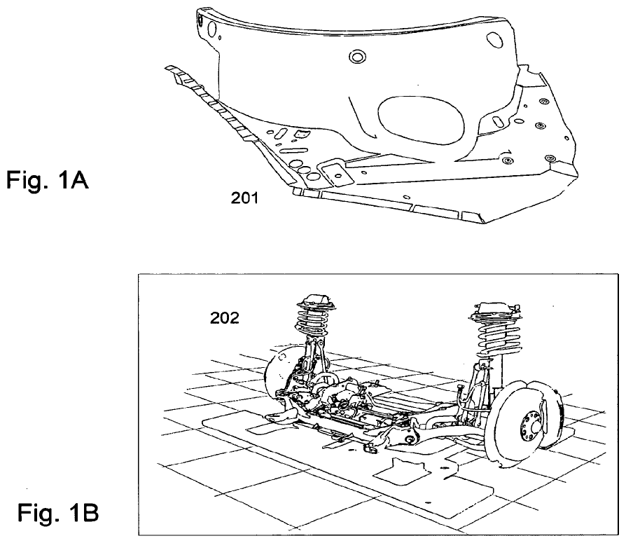

Within the scope of this invention, a method and an arrangement are proposed that allow for automated quality control using a mobile system that comprises at least one camera (that is integrated in a tablet computer, for example). For example, the following possible product groups can be examined, such as products with complex geometric shapes, e.g. a metal sheet 201, as shown in FIG. 1A, or complex assemblies, e.g. an automobile axle 202, as shown in FIG. 1B.

In the following, a specific exemplary embodiment is used to describe how a possible quality test of an object can be carried out.

To test (validate) quality of an object, or part thereof, an approach is proposed that preferably uses the following components:

A first computer-assisted method, e.g. in the form of a computer program (software) for setting up test cases (i.e. different potential objects to be tested), which is, for example, executed on a stationary computer such as a PC.

A second computer-assisted method, e.g. in the form of a computer program (software) for performing a computer vision-based quality test of an object, which is, for example, executed on a tablet computer. Additional components, such as a stationary computer and/or server computer for conducting specific arithmetic operations, may be used additionally, as already described.

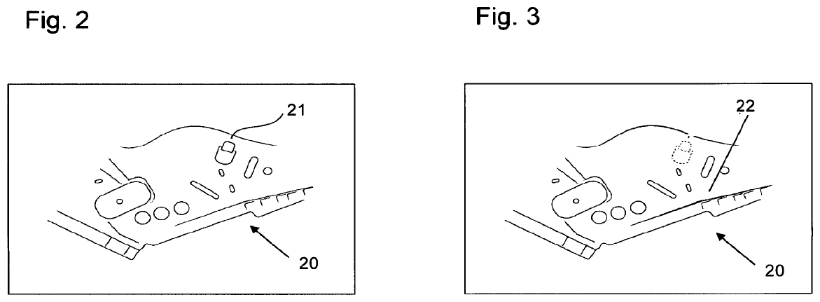

One embodiment for the first computer-assisted method is described in more detail below with reference to FIGS. 2 and 3:

On the basis of a computer-assisted data model 20 (e.g. CAD data; CAD stands for “Computer Aided Design”) of the test object—in this case, a metal sheet —, one or more part geometries of the test object are defined, which incorporate the following tasks for the automated test:

“Test Geometry”:

A test geometry 21 defined within the data model 20 describes a geometric sub-area, for example a punched-out area, the correct form of which and/or placement within the test object is to be tested. For example, the correct position and/or design of the punch-out 21 in the test object can be tested (FIG. 2).

“Reference Geometry”:

A reference geometry 22 defined within the data model 20 defines the reference system against which a test is carried out. The reference geometry 22 may, for example, be specified interactively by the user using the setup software. In this case, the test geometry 21 may, for example, be overlaid with a covering geometry, and flexible components (e.g. cables or deformable objects) can be removed from the reference geometry, leaving rigid geometry parts only. FIG. 3 illustrates an embodiment of a reference geometry 22 that does not include the element to be tested (the punch-out 21 according to FIG. 2) but only includes the rigid elements in the vicinity of the test element.

If a quality test does not involve complex geometric objects but assemblies, the test geometries and reference geometries can consist of rigid sub-components of the assembly, which are often modelled in CAD as separable sub-accounts.

“Test Pose”:

In addition to defining the reference geometry and the test geometry, one or more test poses are specified in the next step. This is important because a specified test pose can ensure accurate tracking (in the camera image) of both the test geometry and the reference geometry from the test pose. This allows for the registration of the mutual relative orientation of the test geometry and the reference geometry.

The tracking accuracy depends (among others) on the distance between the camera and the test object, as well as on the structure to be tested, which can be captured from a specific camera pose. Therefore, accuracy can principally not be determined independently from the test pose. For this reason, to replicate a test, it is crucial for the camera to be positioned in the same or at least similar pose in relation to the test object.

Several documents are known for model-based tracking and for registering objects with digital models, such as EP 2 339 537 A or US 2012/120199 A. However, the tracking methods described therein, which can in principle also be applied to this invention, are in those documents not used for automated quality tests, and the poses (position and orientation) of the objects are not registered in relation to one another to register the geometrically correct orientation of the objects in relation to one another.

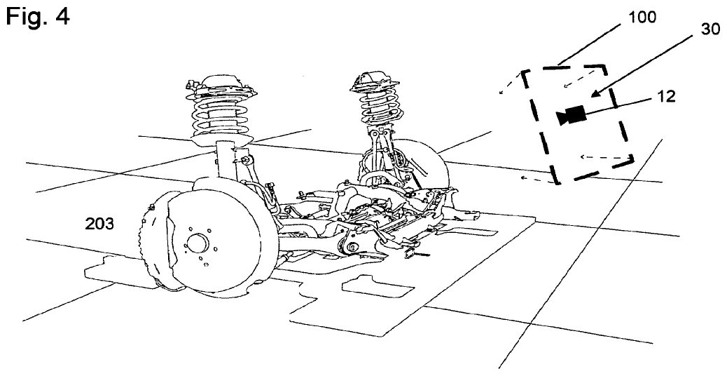

FIG. 4 schematically illustrates an embodiment of an object 203 to be tested (in this case, a vehicle axle) with a visualization of the test pose 30 represented by a marking, which is here implemented as a frame 100. Typically, a test pose is the target pose (position and orientation) of a camera 12, in which the camera 12 captures one or more images of the object 203 to be tested for a quality test to be carried out of the object 203 at the desired location. The test pose is, for example, determined and specified by the user within the data model 20.

According to a preferred variant, to determine the test pose 30 within the data model 20, the user specifies a pose for the camera 12 from which the object to be tested (in this case, the part of the vehicle axis 203 to be tested) and at least part of the reference geometry 22 are visible for the camera 12. The test pose 30 is preferably specified in relation to the object 203 to be tested. The visualization of the test pose 30 is also preferably conducted in relation to the object 203 to be tested.

In this context, FIG. 6 illustrates a possible arrangement 1 for testing the quality of an object according to one embodiment of the invention. It shows an arrangement in which at least part of the processing apparatus, for example in the form of one or more microprocessors on one or more circuit boards, is implemented in a mobile data processing apparatus 11. This may in turn be on a mobile PC (laptop), a tablet computer, a smartphone or wearable computer (general term for portable (small) computers or computer systems integrated in clothing or worn (directly) on the body, such as smartwatches, headsets or similar) included therein or coupled thereto. In the present exemplary embodiment, the mobile data processing apparatus 11 is contained in a smartphone or tablet computer 10.

The visual display device 13 can in principle comprise any suitable screen type or visual display and can be integrated in or be separate from the tablet computer 10. For example, the optical display device 13 is or comprises an LCD or OLED display, which is integrated in the tablet computer 10.

In principle, the camera 12 used can be any camera that is suitable for capturing digital images (pictures) of reality and can, as the camera apparatus 12, also comprise several integrated (for example a stereo camera) or distributed cameras. In the present exemplary embodiment, the camera 12 is integrated in the tablet computer 10, for example on its rear side, which faces away from the display device 13. The data processing apparatus 11, the camera 12 and the display device 13 are thus integrated in a common housing 14, providing the user with all the required components in one compact system. However, these components can also be used as distributed system components that are wired or wirelessly connected with one another.

As already described above, a second part of the processing apparatus, which performs the quality test, may be implemented by a remote computer 15, to which one or more arithmetic operations, such as tracking, can be outsourced, if required. The remote computer 15, e.g. a server computer, can be wirelessly coupled to the tablet computer 10 or the mobile data processing apparatus 11, for example through a network 16 such as the Internet.

Likewise, a mobile PC (laptop) 17, which can run the above-described program for defining the test geometry, reference geometry and test pose, can be wirelessly coupled to the tablet computer 10.

Once the first phase of the quality test using the program described above to define the test geometry, reference geometry and test pose, which was, for example executed on the laptop 17 or on a stationary PC, has been completed, the set up test environment (such as one or more test geometries, reference geometries, test poses) is transferred to or deployed on the mobile computer system, in this case the tablet computer 10.

The second computer-assisted method, for example in the form of a program, is then executed to carry out the computer vision-based quality test of an object.

Referring again to FIG. 4, the tester guides the camera 12 to the test pose 30, which was previously defined in the setup program, to carry out a quality test on the object 203. The test geometry 21 and the reference geometry 22 can be easily identified from this test pose 30, allowing for the test to be carried out reliably. The distance from the camera 12 to the test object in this pose is also known, so that the accuracy of the test can be reproduced. The tester is directed to this camera pose by a marking, here in the form of a frame 100, also referred to as a so-called “View Point Indicator”, which is shown on the display device 13 in an augmented reality application. The “View Point Indicator” indicates the test pose 30 which the tester is directed to. For example, the frame 100 specifies the position where the tester should place the tablet computer 10 with its rectangular housing such that the frame 100 surrounds the tablet computer 10 to assume the test pose.

When capturing an image of the test object, the pose of the camera 12 might not precisely correspond to the test pose 30 but be located in the area around the test pose 30. For the purposes of the present invention, it is sufficient if the camera pose is within a range that includes the test pose 30. This range may include deviations in the position and/or orientation of +/−10%, for example from the defined test pose 30 (for example with respect to a distance or orientation to the test object).

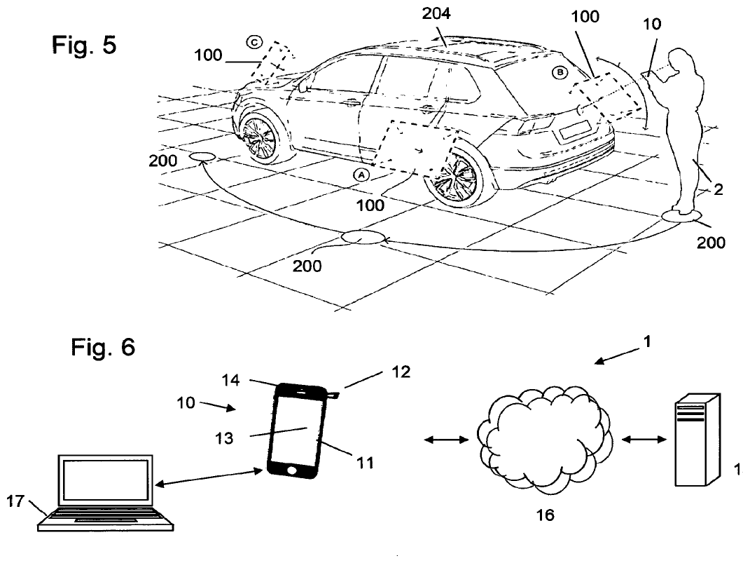

As shown in more detail in FIG. 5, one or more test poses 30 are specified for the user 2 (tester) by corresponding markings 100 (“View Point Indicator”). For example, the position and orientation of the tablet 10, to which the real tablet is to be directed for the AR inspection, are displayed. In addition to the test pose, poses on the floor where the tester 2 is to position themselves may also be displayed, for example by corresponding floor markings 200 (so-called Ground Point Indicators). These Ground Point Indicators 200 are, for example, defined through orthogonal projection of the defined View Point Indicators 100 onto the floor. The floor markings can, for example, be determined by using a SLAM (Simultaneous Localization and Mapping)-based method, which can be determined as a standard method for many current smartphone/tablet systems and their integrated software. With the ideal camera pose at the view point, the optimal position in relation to the object 204 can also be located and visualized.

The View Point Indicators thus serve as an assistance visualization and are displayed to the user 2, for example as a virtual frame 100, for target positioning in the quality test in the field of view of their augmented reality application. The View Point Indicators are specified in relation to the object to be tested and to the tracked object, and visualized accordingly.

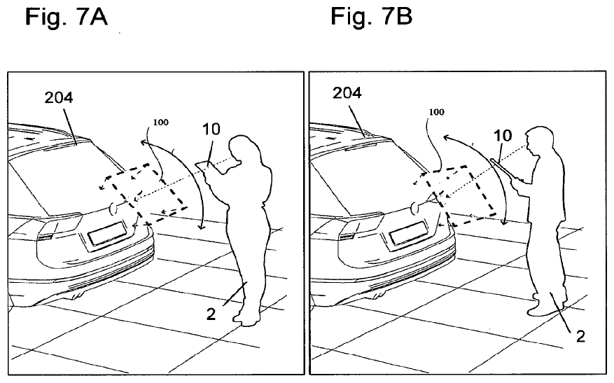

One significant advantage of the present invention is that quality tests carried out at different points in time and/or by different users can be better reproduced and automated. In this context, FIGS. 7A and 7B show schematic representations of different users 2, who create the same documentation step for the object 204 from the same test pose (visualized by the frame 100) at different points in time, whereby the quality test becomes reproducible.

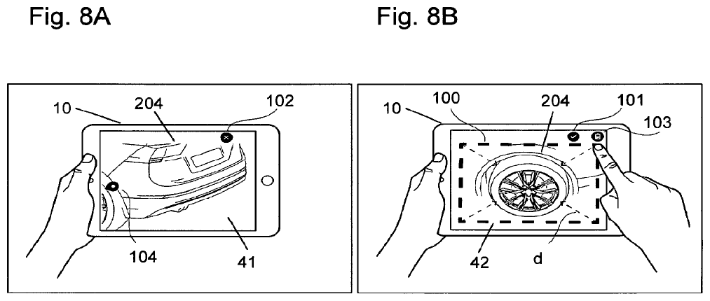

FIGS. 8A, 8B each show an image, 41 and 42, respectively, on the display of a tablet computer 10 during a quality test procedure according to one embodiment of the invention. Here, a symbol 102 (e.g. X symbol) is shown when a tracked camera pose is identified as being invalid for the automated test by the processing apparatus (FIG. 8A). If applicable, a further symbol 104 can be used to indicate the direction where user 2 should move the camera position or the tablet 10 to assume the test pose 30. FIG. 8B shows an image 42 of the camera where a tracked camera pose is valid for the automated test. This is, for example, indicated by a tick symbol 101. For this purpose, the user 2 places the tablet 10 within the virtual frame 100 to assume the test pose 30. A menu with additional functions can be accessed via a button 103. In the visualization of the test pose, a distance d between the marking 100 (and thus the test pose 30) and the object 204 to be tested may also be shown on the display.

With the visualization of the test pose and the user 2 assuming the corresponding position, the following steps according to one embodiment of the invention are carried out for automated and reproducible quality testing.

First, the camera pose in relation to the reference geometry 22 is tracked in the image captured by the camera 12 (camera image). Furthermore, the camera 12 is aligned to ensure that the deviation between the target pose (test pose) and the actual pose does not exceed a predetermined threshold, for example. This threshold (for example for the positioning and/or orientation, in each case in several dimensions) defines, for example, a (similarity) range within which the camera pose should be located and which also includes the test pose. In this case, the camera pose is classified as being valid. In the next step, the test geometry 21 in relation to the reference geometry 22 from a valid camera pose is tracked, i.e. tracked in the image captured by the camera. For this purpose, various tracking methods known to those skilled in the art can be used, as already described. If the tracked actual pose of the test geometry 21 in relation to the target pose of the test geometry 21 defined within the CAD model 20 does not exceed a predetermined threshold, the test step is classified as “OK” (okay); otherwise, it is classified as “nOK” (not okay). “OK” means that the respective object is in the correct condition. Correspondingly, “nOK” means that the respective object is not in the correct condition. In principle, this calculation corresponds to the determination of a parameter (e.g. a comparison operator based on a defined metric), which is determined by comparing the relation between the pose of the tracked test geometry 21 and the target pose of the test geometry 21 defined within the data model 20. Accordingly, a quality indicator (here: “OK”, “nOK” containing information about a quality property of the tested object (here: whether the test geometry is correctly positioned or aligned in the real product) is calculated and output to the user, e.g. via the display device 13, or acoustically.

In this context, other quality indicators and quality properties can, of course, also be used in connection with the present invention. For example, quality indicators that provide information about the degree of matching or no matching, e.g. the extent to which the respective test geometry deviates, can be applied as well.

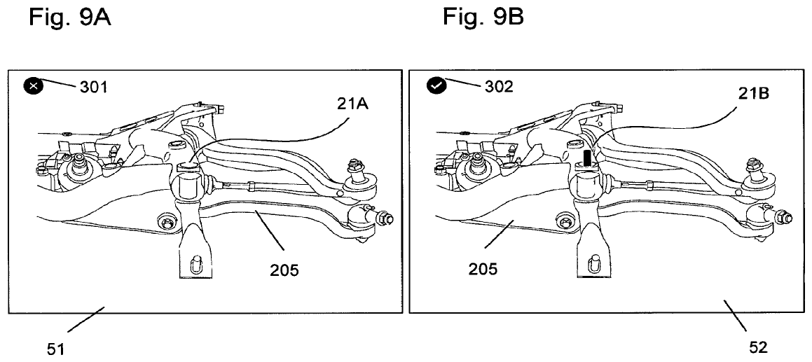

In the following, a further exemplary application case is described with reference to FIGS. 6 and 9A, 9B. A company specializing in manufacturing complex vehicle axles, which can be configured for different vehicle types, is planning to conduct a quality test of a specific part of a given vehicle axle. Various tests based on CAD data are, for example, carried out for each manufactured axle. One of the tests, for example, involves checking whether a particular threaded bolt is precisely aligned with an integral subframe of an axle 205.

To set up the test, the user, for example a test engineer, carries out the following steps of the test:

The test engineer initiates the program (first part of the method as described above) to set up the test cases. The test engineer loads the CAD data on the axle to be tested into a computer (e.g. a laptop 17 according to FIG. 6). The test engineer then specifies the threaded bolt within the CAD model 20 as the test geometry 21 and the integral subframe within the CAD model 20 as the reference geometry 22. The test engineer also defines a camera pose as the test pose 30 within the CAD model 20, allowing for a visualization of the threaded bolt and the integral subframe. In this embodiment, the test engineer instructs these steps, and the respective data are defined, recorded or stored in the processing apparatus, for example the laptop 17 (for example a microprocessor with an associated memory) for further processing later. However, these steps could also be carried out, at least in part, on a tablet computer 10 or a server computer 15, for example as shown in FIG. 6.

It is also conceivable for the test geometry, reference geometry and/or test pose to also be defined at least partially automatically in the processing apparatus, for example with the support of intelligent or user-instructed recognition algorithms, which are stored in the processing apparatus or transmit results to the processing apparatus.

After specifying this test step, further test steps can be defined, if applicable. Upon completing the test plans, these test plans including the data described above are transferred to the tablet computer 10, which is handed over to a quality tester (who may not be the test engineer).

The tester then performs a quality test comprising the following steps:

The tester initiates the tracking using the reference geometry 22; i.e. the camera pose of the camera 12 or the tablet computer 10 (which the camera 12 is integrated in) is registered in the coordinate system of the reference geometry. In an augmented reality visualization on the display device 13 of the tablet computer 10, the tester is, by means of a “View Point Indicator” 100, shown the previously defined test pose 30 in relation to the reality shown (see for example FIG. 5). The tester then aligns the tablet computer 10 as specified in the augmented reality visualization of the View Point Indicator.

If the tracked pose of the camera 12 (and consequently, the tracked pose of the tablet computer 10) deviates by more than 2° from the planned camera or tablet orientation and by more than 2 mm from the planned camera or tablet position, an X icon 102 (FIG. 8A) is displayed for the tester, and when the deviation of the orientation is less than 2° and less than 2 mm, respectively, a tick symbol 101 (FIG. 8B) is displayed. The tester can then carry out a valid quality test.

The reference geometry 22 is tracked in the camera image 51 or 52, respectively, from the test position assumed, and the test geometry 21 is also tracked in relation to the reference geometry. If the tracked pose of the test geometry 21 deviates by less than 1° and 1 mm from the target orientation or target position, respectively, as defined within the CAD model, the test geometry is marked accordingly (e.g. highlighted or colored green, see test geometry 21B according to FIG. 9B), and is otherwise marked differently (e.g. colored red); see test geometry 21A according to FIG. 9A. In the first case, the pose of the tracked test geometry is found to be okay, in the other case, to be not okay.

If the test geometry is found to be okay, the test case is automatically classified as an “OK” case, and otherwise as a “nOK” case. For this purpose, a tick symbol 302 for “OK” (“okay”) or an X symbol 301 for “nOK” (“not okay”) can be shown. The tester is then directed to the next test point via the View Point Indicator 100, if applicable.

According to another aspect of the invention, a quality test may not only be carried out at the object level. It is also possible to track individual edges, which describe the geometry of an object to be tested, in relation to the test geometry, thereby indicating which areas of the test geometry deviate to a particular large extent.

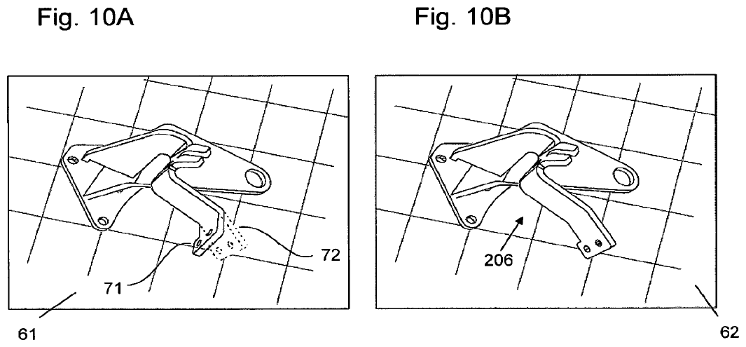

Such an edge-based test may also be carried out without referring to a reference geometry. In the following, one embodiment of such a quality test method is described with reference to FIGS. 10A and 10B. FIG. 10A, 10B show an embodiment of a product to be tested, here a metal support 206, wherein the quality test is carried out on the basis of an edge-based test without referring to a reference geometry.

FIG. 10A shows a camera image 61 of the metal support 206 having a first shape in which one end of the arm is bent, while FIG. 10B illustrates a camera image 62 of the metal support 206 having a second shape in which the end of the arm is straight. A quality test should now determine whether the metal support according to the camera image 61 corresponds to a proper metal support.

First, the metal support 206 as shaped according to FIG. 10A or part thereof is defined as the test geometry in a CAD model. Then, the camera 12 or the tablet computer 10 is placed in a previously defined test pose 30 (for example instructed by showing the “View Point Indicator” 100), as described for the previous exemplary embodiments. A respective camera image 61, 62 is then captured from the test pose and one or more edges in the camera image 61 and in the camera image 62 are tracked, each in relation to the test geometry.

Here, model-based tracking methods are, for example, used that associate rendered model edges and edges recognized in the camera image. See also: Wuest, Harald; Vial, Florence; Stricker, Didier: “Adaptive Line Tracking with Multiple Hypotheses for Augmented Reality”, in: Institute of Electrical and Electronics Engineers (IEEE): ISMAR 2005: Proceedings of the Fourth IEEE and ACM International Symposium on Mixed and Augmented Reality. Los Alamitos, Calif.: IEEE Computer Society, 2005, pp. 62-69.

Specifically, first edges 71 that reach or exceed a predefined first degree of matching between the CAD model of the metal support 206 and the camera image are then determined in the respective camera image, as are second edges 72 that fall below a predefined second degree of matching between the CAD model and the camera image. For example, edges 71 for which a good match is found between the CAD model and the captured object, are colored green, while edges 72 for which no match can be found are colored red (shown as dashed lines in FIG. 10A). This means there are no model edges that can be associated with the edges 72 detected in the camera image 62.

Here, reaching or exceeding the first degree of matching (e.g. a correspondingly defined threshold) defines a good match, while falling below a second degree of matching (which can be the same as or different from the first degree, e.g. corresponds to the defined threshold) means no match.

A quality indicator can then be determined on the basis of the determined first and/or second edges 71, 72. For example, an OK/nOK classification is then carried out using a ratio of the second edges 72 relative to all edges rendered (recognized) in the camera image. Such a quality indicator can, similar to that in FIGS. 9A, 9B, for example be output on the display of the tablet computer 10 as a tick symbol 302 in the case of “OK”, or as an X symbol in the case of “nOK”.

Furthermore, the output can also inform the user about which of the edges match and which ones do not match. The user can thereby, for example, also draw local or quantitative conclusions as to where and, if applicable, what type of quality defects there are.

In this embodiment, as in the case of the other embodiments, an output of the quality indicator may not only be shown visually on a display but may also be output to the user acoustically or haptically via a corresponding human-machine interface.

Aspects of the present invention thus include the following advantageous features and effects:

Different people can create mostly continuous inspections and inspection documentation at different times, i.e. quality tests become reproducible.

Quality tests no longer depend on the skills or experiences of a single user, i.e. the quality test is partially automated.

Based on the output of the distance between a View Point Indicator and the target object, the user, in addition to defining an ideal test pose, also has the possibility to assess the spatial feasibility thereof (if the pose is too far away, it might not be possible to assume this pose due to the environment).

The specified test poses can be transferred from one test case to another in case of similar test objects and might need to be only slightly modified.

The successful assumption of a View Point Indicator can be validated via the tracking technology, so that e.g. a valid quality test is only possible when the camera is in a pose that corresponds to or is similar to the given test pose.

A test process can be instructed very intuitively because the user can be very intuitively guided through complex test processes using the View Point Indicator.

1. A method for testing quality of an object in a real environment using at least one camera for capturing at least one image of the real environment, an optical display device, and a processing apparatus, which is connectable with the at least one camera and the optical display device, the method comprising the following steps:
providing a computer-assisted data model of an object of the real environment to be tested;
defining a test geometry as a geometric sub-area within the data model,
defining a reference geometry within the data model as a reference system for conducting a test;
defining, by the processing apparatus, a test pose, in which the camera should be placed by the user as target positioning for a quality test to be carried out of the object to be tested;
visualizing, by the processing apparatus, the test pose on the optical display device;
capturing, by the camera, at least one image of the real environment, the pose of which camera is in a range that includes the test pose, and tracking, by the processing apparatus, the test geometry and the reference geometry in the at least one image;
determining, by the processing apparatus, a pose of the tracked test geometry in relation to the reference geometry, and determining at least one parameter on the basis of how the pose of the tracked test geometry is in relation to a target pose of the test geometry defined within the data model;
determining, by the processing apparatus, a quality indicator containing information about at least one quality property of the object to be tested on the basis of the at least one parameter; and
outputting, by the processing apparatus, the quality indicator to the user via a human-machine interface.

2. The method according to claim 1, wherein a pose of the camera is registered in a coordinate system of the reference geometry.

3. The method according to claim 1, wherein the quality indicator indicates first information that indicates satisfactory quality if the pose of the tracked test geometry deviates by less than a predetermined distance, particularly 1 mm, from a target position of the test geometry defined within the data model, and/or deviates by less than a predetermined angle, particularly 1 degree, from a target orientation of the test geometry defined within the data model.

4. A method for testing quality of an object in a real environment using at least one camera for capturing at least one image of the real environment, an optical display device, and a processing apparatus, which is connectable with the at least one camera and the optical display device, the method comprising the following steps:
providing a computer-assisted data model of an object of the real environment to be tested;
defining a test geometry as a geometric sub-area within the data model;
defining, by the processing apparatus, a test pose, in which the camera should be placed by the user as target positioning for a quality test to be carried out of the object to be tested;
visualizing, by the processing apparatus, the test pose on the optical display device;
capturing, by the camera, at least one image of the real environment, the pose of which camera is in a range that includes the test pose, and tracking, by the processing apparatus, one or more edges in the image in relation to the test geometry;
determining, by the processing apparatus, first edges in the image that reach or exceed a predefined first degree of matching between the data model and the image, and second edges in the image that fall below a predefined second degree of matching between the data model and the image;
determining, by the processing apparatus, a quality indicator containing information about at least one quality property of the object to be tested on the basis of the determined first and/or second edges; and
outputting, by the processing apparatus, the quality indicator to the user via a human-machine interface.

5. The method according to claim 1, wherein the definition of the test geometry within the data model and/or the definition of the reference geometry within the data model is instructed by the user and stored in the processing apparatus.

6. The method according to claim 1, wherein, to determine the test pose, the user specifies a pose of the camera within the data model from which the object to be tested and, if the reference geometry has been defined, at least part of the reference geometry are visible for the camera.

7. The method according to claim 5 wherein the processing apparatus comprises at least one first data processing device and one second mobile data processing device, and the definition of the test geometry and/or the definition of the reference geometry is instructed by the user on the first data processing device and, once completed, the defined test geometry or reference geometry, respectively, is transferred from the first data processing device to the mobile data processing device and stored therein.

8. The method according to claim 1, in which the test pose is specified in relation to the object to be tested, and the visualization of the test pose is carried out on the optical display device in relation to the object to be tested.

9. The method according to claim 1, in which the visualization of the test pose on the optical display is provided by the processing apparatus such as to be displayed as at least one marking, specifically a virtual frame, in the field of view of an augmented reality application on the optical display device.

10. The method according to claim 9, in which a distance between the marking and the object to be tested is output to the user with the visualization of the test pose.

11. The method according to claim 9, in which the visualization of the test pose on the optical display device is provided by the processing apparatus such as to additionally show at least one floor marking indicating to the user where on the floor the user should position themselves to assume the test pose.

12. The method according to claim 1, wherein before capturing the at least one image of the real environment with the camera, the pose of the camera in relation to the test pose is tracked by the processing apparatus, and upon determining that the tracked camera pose deviates by more than at least one predefined parameter from a target orientation and/or a target position of the test pose, the user is notified via the human-machine interface that the camera should not capture the at least one image of the real environment, and otherwise, they are notified that the camera can capture the at least one image of the real environment.

13. The method according to claim 12, wherein the processing apparatus, upon determining that the tracked camera pose deviates by more than the at least one predefined parameter from a target orientation and/or a target position of the test pose, does not allow for a subsequent quality test of the object to be tested.

14. A computer program product comprising software code sections that are configured to execute a method according to claim 1 when loaded to an internal memory of at least one data processing apparatus.

15. An arrangement for testing quality of an object of a real environment, by means of a processing apparatus which is coupleable with at least one camera for capturing at least one image of the real environment and an optical display device, wherein the processing apparatus is configured to carry out the following steps:
providing a computer-assisted data model of an object of the real environment to be tested;
defining a test geometry as a geometric sub-area within the data model;
defining a reference geometry within the data model as a reference system for conducting a test,
defining a test pose in which the camera should be placed by a user as target positioning for a quality test to be carried out of the object to be tested;
visualizing the test pose on the optical display device;
receiving at least one image of the real environment captured by the camera, the pose of which camera is in a range that includes the test pose, and tracking the test geometry and the reference geometry in the at least one image;
determining a pose of the tracked test geometry in relation to the reference geometry, and determining at least one parameter on the basis of how the pose of the tracked test geometry is in relation to a target pose of the test geometry defined within the data model;
determining a quality indicator containing information about at least one quality property of the object to be tested on the basis of the at least one parameter and
outputting the quality indicator to the user via a human-machine interface.

16. An arrangement for testing quality of an object of a real environment, by means of a processing apparatus which is coupleable with at least one camera for capturing at least one image of the real environment and an optical display device, wherein the processing apparatus is adapted to carry out the following steps:
providing a computer-assisted data model of an object of the real environment to be tested;
defining a test geometry as a geometric sub-area within the data model;
defining a test pose, in which the camera should be placed by a user as target positioning for a quality test to be carried out of the object to be tested;
visualizing the test pose on the optical display device;
receiving at least one image of the real environment captured by the camera, the pose of which camera is in a range that includes the test pose, and tracking one or more edges in the image in relation to the test geometry;
determining first edges in the image that reach or exceed a predefined first degree of matching between the data model and the image, and second edges in the image that fall below a predefined second degree of matching between the data model and the image;
determining a quality indicator containing information about at least one quality property of the object to be tested on the basis of the determined first and/or second edges; and
outputting the quality indicator to the user via a human-machine interface.

17. The arrangement according to claim 15, wherein at least part of the processing apparatus is implemented as a mobile data processing apparatus, specifically contained in a mobile PC, tablet computer, smartphone or wearable computer, or coupled thereto.

18. The arrangement according to claim 17, wherein at least part of the processing apparatus, the camera and the optical display device are integrated in a common housing.

19. The arrangement according to claim 15, wherein at least a first part of the processing apparatus is implemented as a mobile data processing apparatus and a second part of the processing apparatus is implemented as a remote computer, which are coupleable with one another, particularly via a network, particularly the Internet.
